(19) United States
(12) Patent Application Publication
(10) Pub. No.: US 2016/0170599 A1
(43) Pub. Date: Jun. 16, 2016

(54) DATA TRANSFER AID ON A TOUCH INTERFACE

(71) Applicant: ORANGE, Paris (FR)

(72) Inventors: Delphine Guegan, Betton (FR); Sylvie Jumpertz, Rennes (FR); Juliette Wolff, Montreal (CA)

(21) Appl. No.: 14/958,895

(22) Filed: Dec. 3, 2015

(30) Foreign Application Priority Data
Dec. 15, 2014 (FR) 1462441

(51) Int. Cl. G06F 3/0486; G06F 3/0484; G06F 3/0488

(52) U.S. Cl. CPC G06F 3/0486; G06F 3/04883; G06F 3/04845

(57) ABSTRACT

The invention relates to a method for aiding the data transfer between a sending user and a receiving user by means of a touch interface of a terminal screen. Each user has a data portfolio and is represented on the screen by a graphical representation. The method is such that it comprises the steps of swiping (E201) the graphical representation of the sending user toward the graphical representation of the receiving user on the screen of the terminal, sending (E202) a command to a management unit to initialize the data transfer from the data portfolio of the sending user to the data portfolio of the receiving user when the graphical representation of the sending user is at a predefined distance from the graphical representation of the receiving user, sending (E206) a data transfer validation command to the management unit when the graphical representation of the receiving user moves away (E205) from the graphical representation of the sending user; and sending (E204) a data transfer cancellation command to the management unit when the graphical representation of the sending user moves away (E203) from the graphical representation of the receiving user. It also relates to a device implementing the method.

The present invention relates to the field of interactions between users for a data transfer and, more particularly, on a transfer aid on the basis of interactions on a touch interface.

In many situations in daily life, it is often necessary to carry out a data transfer from one person to another.

For example, within the same family, it is customary for parents to allocate an allowance to their young or teenage children.

When the money is in a bank account, the transfer can be made by bank transfer. In order to initiate this bank transfer and allocate the correct amount, it is necessary to enter an amount explicitly before the transfer can take place.

The fact of entering an amount explicitly may be a source of errors due to an incorrect operation on a keyboard or through ignorance on the part of persons who are not used to manipulating numbers or who have difficulties with reading or writing.

The problem also arises for other types of data transfer such as, for example, the rights to the quantities of data allocated to a phone or Internet package or other amounts of data that are to be shared. This type of transfer may also be virtual and provisional for a game application where exchanges of quantities of data are carried out between players. In all cases, the user who wishes to transfer a quantity of data electronically to another user must enter a predetermined amount in text form into a transfer file or choose from quantities proposed.

Input errors or ignorance of existing transfer tools may result in an increase in the communication exchanges between terminals belonging to the user wishing to transfer his data and transfer management servers. Furthermore, the time required for this type of operation is very substantial for some users. This contributes to a greater power consumption, the operations initiating the transfer of these data often being burdensome and not being within the capability of every individual. It is important to avoid any unnecessary power consumption, notably for electrical appliances requiring a battery recharge.

A need therefore exists to simplify this type of interaction in order to enable the largest number of individuals to carry out this type of transfer efficiently.

The present invention improves the situation.

To do this, it proposes a method for aiding the data transfer between a sending user and a receiving user by means of a touch interface of a terminal screen, such that each user has a data portfolio and is represented on the screen by a graphical representation. The method is such that it comprises the following steps:
swiping the graphical representation of the sending user toward the graphical representation of the receiving user on the screen of the terminal;
sending a command to a management unit to initialize the data transfer from the data portfolio of the sending user to the data portfolio of the receiving user when the graphical representation of the sending user is at a predefined distance from the graphical representation of the receiving user;
sending a data transfer validation command to the management unit when the graphical representation of the receiving user moves away from the graphical representation of the sending user; and
sending a data transfer cancellation command to the management unit when the graphical representation of the sending user moves away from the graphical representation of the receiving user.

The interactions on the proposed interface are thus simple to perform and do not require explicit manipulation of numbers or tables. The data transfer according to the invention is therefore within the capability of a very large number of individuals. The interface process thus proposed allows a man-machine interaction on the terminal that is more efficient and less time-consuming and energy-consuming than existing methods of the prior art. This method therefore allows a considerable time saving compared with conventional data transfer techniques and avoids the input errors that could exist with current systems.

In one particular embodiment, a parameter for displaying the graphical representation of a user varies according to the remaining quantity of data in his portfolio and is updated following the sending of a transfer validation command.

An immediate and clear visualization of the transfer is thus proposed to the users of the transfer method.

In a first embodiment, the steps of swiping and distancing the graphical representations are carried out through touch interaction and touch movement on the screen.

The touch interactions on the tablet or terminal screens are within the capability of a large number of persons and are simple to perform. The man-machine interface for making the transfer is then very efficient.

According to one particular embodiment, the method furthermore comprises a step of creating a graphical object representing the transfer of data originating from the sending user on detection of a touch contact of the sending user on his graphical representation displayed on the screen, the size of the graphical object varying according to the quantity of data to be transferred. The transfer validation command comprises information relating to the quantity of data to be transferred.

The graphical object thus created represents in a tangible manner that which will be transferred, thereby increasing all the more the efficiency of the man-machine interface.

In one particular embodiment, the quantity of data to be transferred is determined according to the duration of touch contact, detected on the screen, on the graphical object representing the data transfer.

It is thus easy to change the amount to be transferred, but without manipulating or entering numbers, which is a source of errors. The user interaction is simple to perform and requires only a minimum of time compared with a text input. Furthermore, the visualization of the amount to be transferred is tangible for the users of the method.

In one alternative embodiment, the quantity of data to be transferred is determined according to a touch movement of rotation on the screen around the graphical object representing the data transfer.

This type of interaction is also simple to perform. This embodiment not only enables the amount of data to be increased by means of a movement in a first direction of rotation, but enables it to be reduced by means of a gesture in a second direction of rotation.

In a second embodiment, the steps of swiping and distancing the graphical representations are carried out through the interaction of pawns identified on the touch interface of the screen and through the movement of the markers on the screen, a marker being associated with a user.

The use of markers dedicated to persons on the one hand enables simple authentication of the person associated with the pawn. The fact of moving a pawn on an interface is a simple interaction that does not require particular computer skills. This action is therefore within the capability of a very large number of individuals.

In one particular embodiment, the method comprises a step of authenticating a pawn on the touch interface of the screen, the authentication requiring the physical contact of the user on his pawn.

This embodiment offers additional security since the respective pawns of the receiving user and the sending user must be authenticated on the touch interface by the physical presence of the two users. In the case where the method is implemented on a single device, the transfer is made only when the two persons are present, thus avoiding the transfer by mistake to a different person. The agreement of the two persons is then immediate.

According to one particular embodiment, the method furthermore comprises the steps of creating a graphical object representing the transfer of data originating from the sending user on detection of the contact of the pawn of the sending user on the touch interface of the screen; of determining the quantity of data to be transferred according to an angle of rotation applied to the pawn of the sending user on the touch interface of the screen, the size of the graphical object varying according to the determined data quantity. The transfer validation command comprises information relating to the determined data quantity.

This embodiment also enables a simple interaction in order to cause the amount of data to be transferred to vary without the need to manipulate or input numbers, which is a source of errors. The user interaction is simple to perform and requires only a minimum of time compared with a text input. Furthermore, the visualization of the amount to be transferred is tangible for the users of the method.

This embodiment allows the amount of data not only to be increased by means of a first direction of rotation, but also to be reduced by means of a second direction of rotation. The effect on the quantity of data to be transferred is immediately visible due to the size of the corresponding graphical object.

The present invention also relates to a device for aiding the transfer of data between a sending user and a receiving user comprising a screen with a touch interface. Each user has a data portfolio and is represented on the screen by a graphical representation, the device comprising:
a module for detecting a swiping on the screen of the graphical representation of the sending user toward the graphical representation of the receiving user;
a command-sending module capable of sending a command to a management unit to initialize the data transfer from the data portfolio of the sending user to the data portfolio of the receiving user when the detection module detects that the graphical representation of the sending user is at a predefined distance from the graphical representation of the receiving user;
the command-sending module being capable of sending a data transfer validation command to a management unit when the detection module detects that the graphical representation of the receiving user is moving away from the graphical representation of the sending user; and of sending a data transfer cancellation command when the detection module detects that the graphical representation of the sending user is moving away from the graphical representation of the receiving user.

This device offers the same advantages as the previously described method which it implements.

The invention also relates to a terminal comprising a device of this type.

It relates to a computer program comprising code instructions for implementing the steps of the transfer aid method as described when these instructions are executed by a processor.

Finally, the invention relates to a computer-readable storage medium, integrated or not into the transfer aid device, possibly movable, storing a computer program implementing a transfer aid method as previously described.

Other characteristics and advantages of the invention will become more apparent from a reading of the detailed description which follows, given purely by way of a non-limiting example, with reference to the attached drawings, in which:

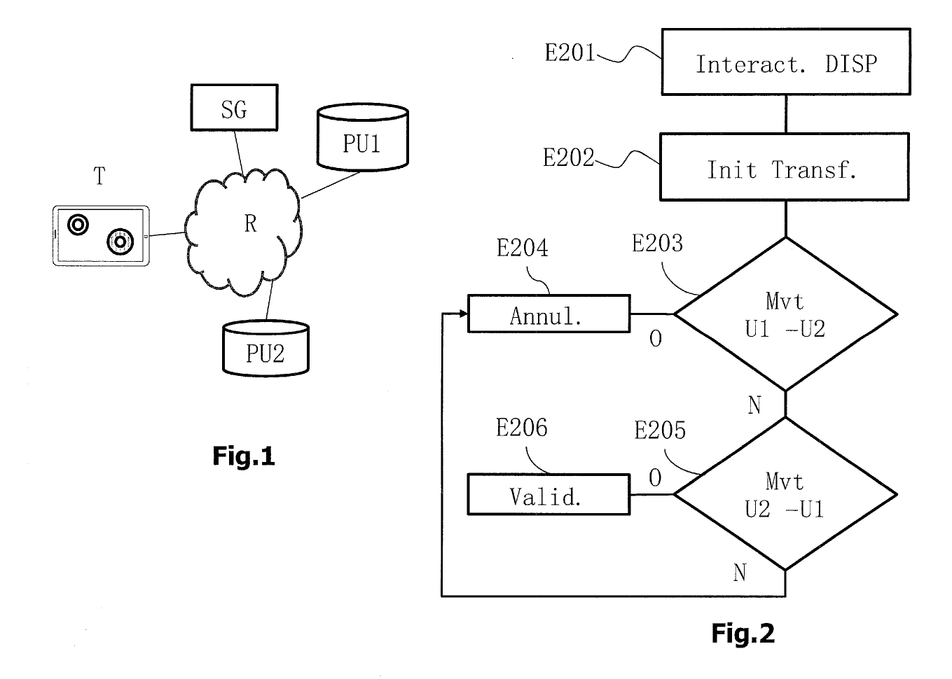

FIG. 1 shows a system comprising a data transfer aid device according to one embodiment of the invention;

FIG. 2 shows, in the form of a functional flow diagram, the main steps of a data transfer aid method according to one embodiment of the invention;

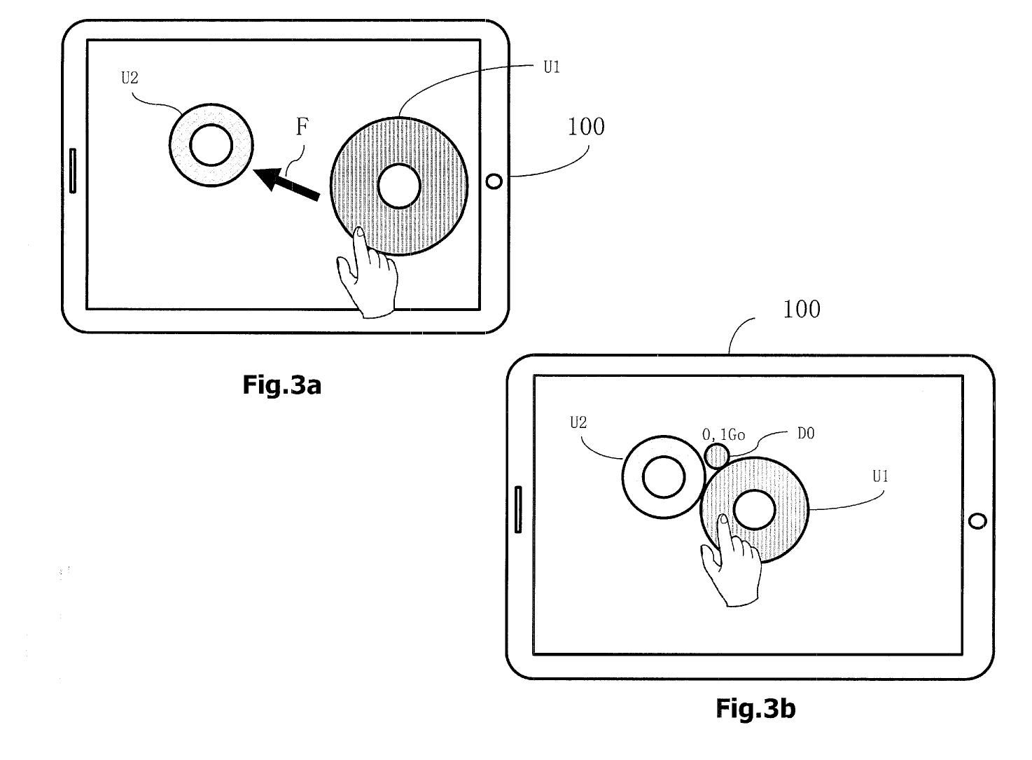

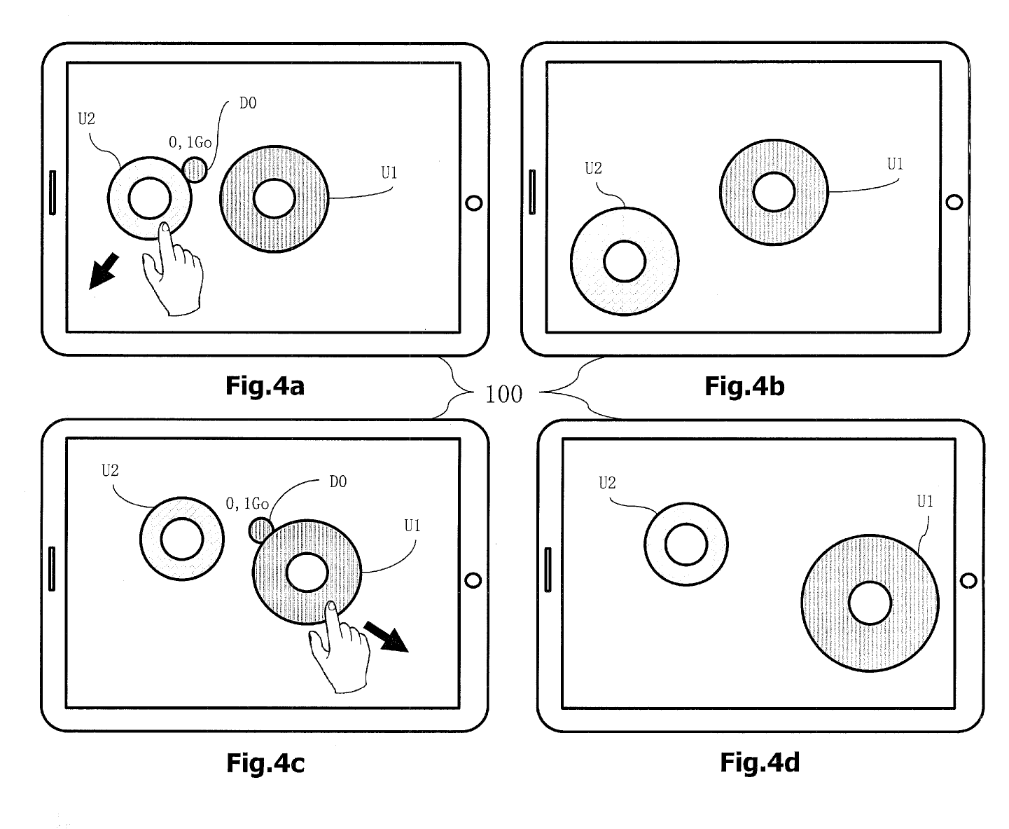

FIGS. 3a, 3b, 4a, 4b, 4c and 4d show the interactions implemented on the touch interface of the screen of the device according to the invention, in a first embodiment;

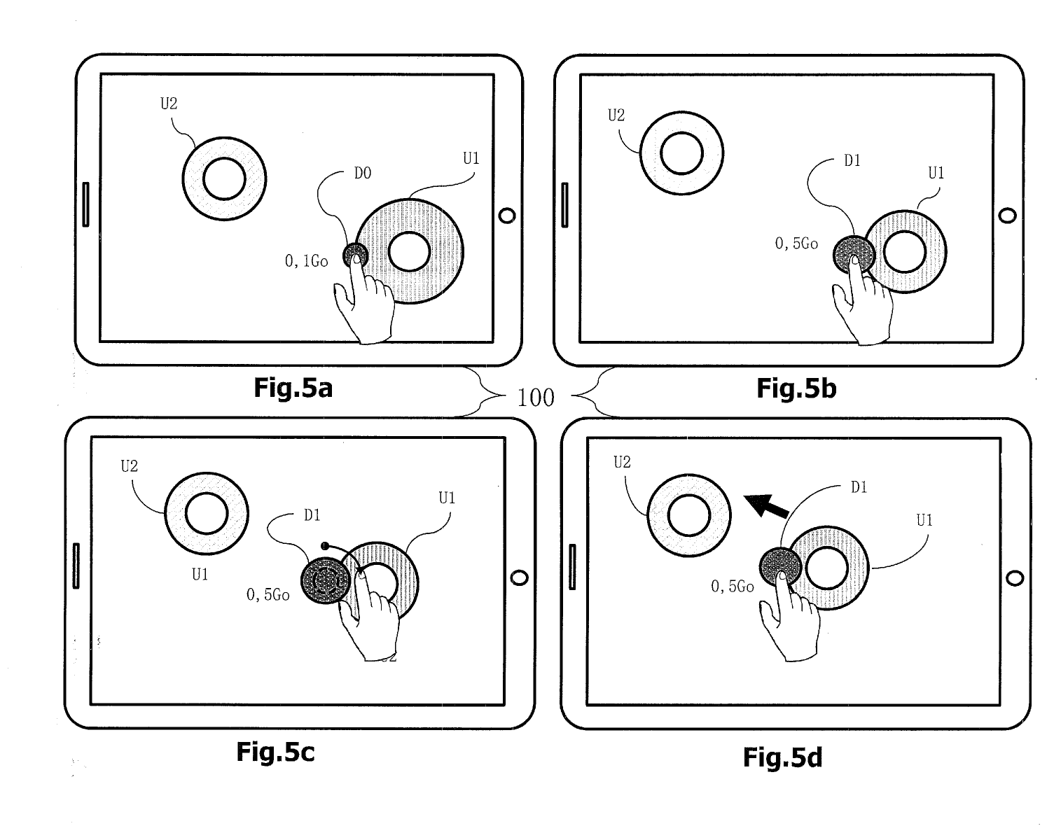

FIGS. 5a, 5b, 5c and 5d show the interactions implemented on the touch interface of the screen of the device according to the invention, in particular embodiments;

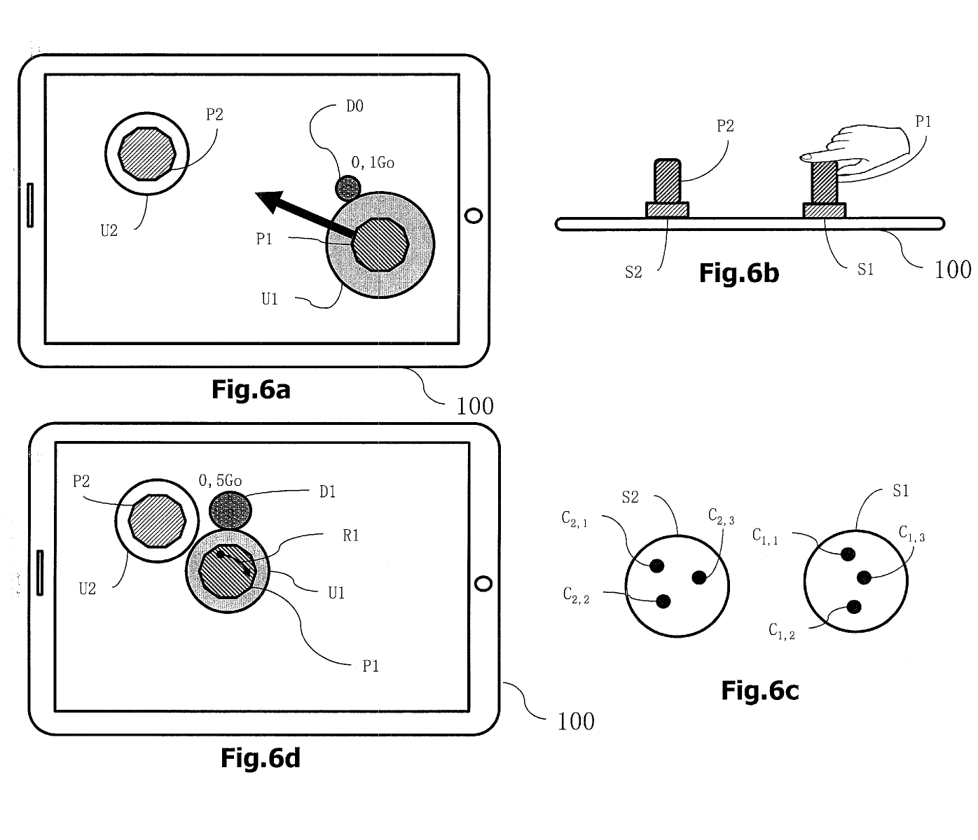

FIGS. 6a and 6d show the interactions implemented on the touch interface of the screen of the device according to the invention, using pawns in a second embodiment;

FIGS. 6b and 6c show the configuration of two pawns according to one particular embodiment of the invention; and

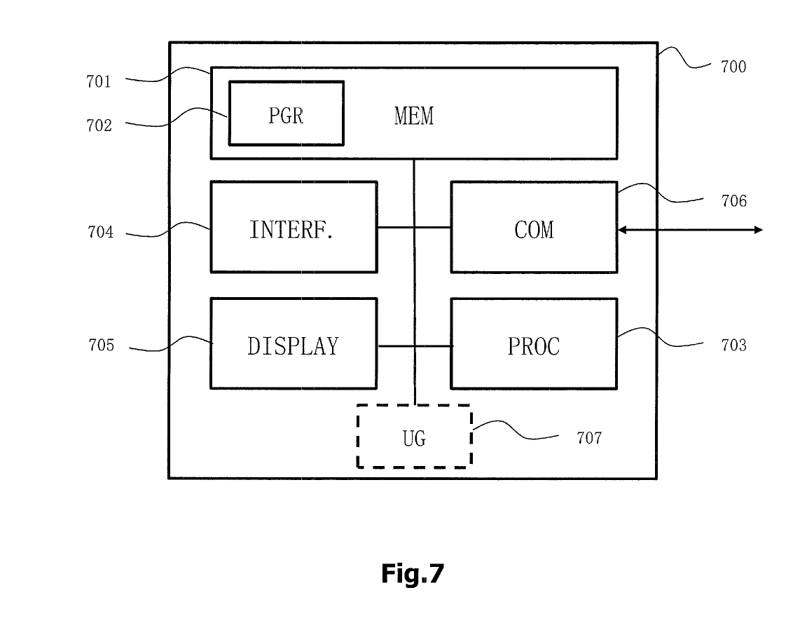

FIG. 7 shows an example embodiment of hardware of a data transfer aid device according to the invention.

FIG. 1 shows the main elements of a communication system comprising a terminal T equipped with a screen with a touch interface capable of interacting with at least one user. The touchscreen of this terminal is capable of controlling a plurality of touch contacts on its surface. The terminal denoted T may, for example, be an electronic tablet, a smartphone, a multimedia table with a touchscreen or, more generally, any electronic equipment having a screen with a touch interface. This terminal communicates via a network R with a data transfer management server SG. This server is capable of collecting information relating to the data transfer between a data portfolio PU1 of a first user and a data portfolio PU2 of a second user.

This management server can also communicate with other respective portfolio management servers such as, for example, a banking server when the data transfer relates to a sum of money, or the server of a telecoms operator when the data transfer relates to an allocation of Internet access rights or a communication time.

In one possible embodiment, the terminal T comprises a data transfer management unit and also comprises the data of the respective portfolios of the users of the transfer. This embodiment is chosen, for example, for game transfer applications.

The terminal implements a data transfer application and detects the interactions implemented on its touch interface in order to determine, on the one hand, the sender and the recipient of the transfer, the data to be transferred and the quantity of data to be transferred in one embodiment of the invention. This terminal implements a data transfer aid method now described with reference to FIG. 2.

The data transfer application implemented by the terminal T displays, for example, different representations of a group of users predefined in a memory, for example during a step of configuring the application.

As shown with reference to FIG. 3a, a representation of a first user is displayed as U1 and a representation of a second user is displayed as U2. In the interests of legibility, only the representations of two users are shown. The number of representations may obviously be greater than two.

The illustration in FIG. 3a of a representation of a user is shown here in the shape of an annular geometric figure. A different geometric shape can obviously be chosen, and the representation may also be displayed in the form of an image, a pictogram, a photo or any other illustration.

Step E201 shown in FIG. 2 is a step of user interaction on the touch interface of the terminal T. This interaction step consists in a swiping of the graphical representation of a first user toward a graphical representation of a second user as shown by the arrow F in FIG. 3a in the case where this swiping step is carried out by means of a touch contact interaction with the finger of the user. This interaction may also be carried out using a stylus or using a pawn in contact with the touch contact surface as explained below in a second embodiment with reference to FIGS. 6a to 6d. This interaction is carried out by the initiator of the data transfer, i.e. by the sending user U1. The second user is then the receiving user U2.

The touch interface in fact comprises means for detecting a touch contact on the screen and the position of this contact on the screen. The detection means are capable of detecting the movement of the contact and the direction of the movement. The display of the representation under the contact point follows the movement of the contact on the screen. The interface of the terminal detects the distance between the display of the representation of the sending user and that of the receiving user. When this distance reaches a predefined value, for example 0 or a few millimeters, the terminal obtains the information relating to the identity of the sending user (position of the initial contact) and relating to the identity of the receiving user (position where the movement stops).

In step E202, the terminal then sends a data transfer initialization command to a transfer management unit, for example via communication means if the management unit is in a management server SG in a communication network, or to a transfer management unit within the terminal. This command comprises at least the identifiers of both the sending user and the receiving user. The command may also comprise the type of data to be transferred, for example according to the type of transfer application implemented in the terminal.

In one particular embodiment, during this step E202, a graphical object is created and displayed on the screen of the terminal in order to implement the transfer. This graphical object shown in FIG. 3b is denoted D0. It is shown in the shape of a circle, but may have a different shape. It may correspond, for example, to a default quantity of data to be transferred. In one example embodiment where the data transfer application relates to a transfer of Internet usage credit to be shared for an Internet offering of an operator, a default quantity may, for example, be 0.1 GB. For a money transfer application, the default quantity may, for example, be [symbol] 10. Other default quantities can obviously be defined.

In other types of application where the data are multimedia files, for example photos, the graphical object then displays the photo to be transferred from a database of the sending user.

As also shown in FIG. 3b, the graphical representation of the sending user comprises a parameter that varies according to the remaining quantity of data in the portfolio of the user. Here, it is the thickness of the ring that varies and said thickness can be seen to have decreased on creation of the graphical transfer object. This therefore represents in a tangible manner the impact that the data transfer will have on the remaining data of the user.

The terminal then identifies the type of touch contact interaction performed on the respective representations of the sending and receiving users. If the user interface detects (O in E203) in step E203 that the graphical representation of the sending user (U1) is moving away from the graphical representation of the receiving user (U2) as shown in FIG. 4c, for example by a swiping of this representation in a direction opposite to that of the displayed location of the representation of the receiving user, step E204 is then implemented. This means, for example, that the sending user has abandoned the data transfer.

In step E204, a data transfer cancellation command is sent to the data transfer management unit. The management unit therefore cancels the transfer preparation.

If the interface detects (O in E205) in step E205 that the graphical representation of the receiving user is moving away from the graphical representation of the sending user, as shown in FIG. 4a, for example by a swiping of this representation in a direction opposite to that of the displayed location of the sending user, step E206 is then implemented.

In step E206, a data transfer validation command is sent to a data transfer management unit, either locally in the terminal or on a management server on a communication network. This management unit manages the transfer of the data from the portfolio of the sending user to the portfolio of the receiving user by translating the data received from the user interface relating to the identity of the respective users and, where relevant, the information relating to the quantity of data to be transferred. The management unit can communicate with other management servers in order to make the transfer, for example to banking servers or to servers of Internet operators in the example embodiments described.

For a game application management where an exchange of data, for example of virtual money, is to be carried out, the management takes place internally within the terminal. The management unit transfers the data from the database comprising the portfolio of a first player to the database comprising the portfolio of a second player.

When the command is sent, the respective representations of the receiving and sending users vary according to the quantity remaining in their portfolio. Thus, as shown with reference to FIG. 4b, the data of the portfolio of the user U1 have decreased (the ring representing U1 has shrunk), whereas the data of the portfolio of the user U2 have increased (the ring representing the user U2 has increased).

In the case where none of the graphical representations of the users has moved (N in E203 and N in E205), after a given delay, step E204 is then implemented and the data transfer does not take place.

Here also, the respective representations of the receiving and sending users vary according to the quantity of data remaining in the portfolio. As shown in FIG. 4d, when the transfer is cancelled, the representation of the user U1 regains its initial size since the transfer does not take place and the size of the user U2 does not vary.

In the embodiment described where the transferred quantity of data is a default value, the interaction enabling the transfer can be performed several times until the desired transferred quantity of data is obtained.

In a different embodiment shown in FIGS. 5a and 5b, the quantity of data to be transferred is determined by an action on the graphical object representing the data transfer. This graphical object may, for example, be created during a contact with a graphical representation of the sending user, here U1 in FIG. 5a. The value of the quantity of data to be transferred is determined according to the duration of touch contact, detected on the screen, on the graphical object representing the data transfer. The quantity of data thus changes from the value 0.1 GB to the value 0.5 GB, as shown by D0 and D1 in FIGS. 5a and 5b. The size of the graphical object representing the transfer also varies according to the quantity of data thus determined.

In one alternative embodiment, the quantity of data to be transferred is determined according to a touch movement of rotation on the screen around the graphical object representing the data transfer, as shown in FIG. 5c. Here also, the quantity changes from the value 0.5 GB in the example shown and the graphical object D1 changes in size as the quantity increases. The transfer can then be initiated by the implementation of steps E201 and E202 by swiping both the graphical representation of the sending user toward the graphical representation of the receiving user and the associated graphical object representing the transfer. This is shown with reference to FIG. 5d. In a different possible embodiment, the determination of the quantity of data to be transferred either by the embodiment shown in FIG. 5b or by that shown in FIG. 5c can take place after the swiping step. In the case where the data transfer is validated in step E206, this command then also comprises the information relating to the data quantity thus determined on the touch interface of the screen.

In the embodiment described above, the actions of swiping and moving graphical representations can be carried out by two users of the transfer or by a single user. The actions on the screen can also be taken into account by the terminal only after an authentication step, for example by entering a code or through text input or by means of a gesture on the touch interface.

Furthermore, in one possible embodiment of the invention, these swiping or moving steps can be carried out by two users on remote terminals. In this case, the graphical representations of the two users are displayed on the remote terminals, communicating with one another, for example, via a mobile communication network. The movements of a graphical representation caused by the action of a user on his touchscreen are communicated to the remote device which displays these movements on its screen. The validation or the cancellation of the transfer is performed according to the movements of the graphical representations. Similarly, the actions on the touch interface enabling the amount of the transfer to be determined are also communicated to the remote device for a display on its screen.

In a second embodiment of the invention, the steps of swiping and distancing the graphical representations are carried out through the interaction of pawns identified on the touch interface of the screen and through the movement of the pawns on the screen, a pawn being associated with a user. In fact, in this example embodiment, a pawn is a physical object in the possession of a user of the transfer aid device. In one example embodiment of a pawn of this type, said pawn has a plurality of contact points (for example three) on the underside which is placed on the surface of the touchscreen of the device. FIGS. 6b and 6c show two pawns P1 and P2 each with a surface S1 and S2 in contact with the touchscreen of the device 100. These surfaces are provided with respective contact points C_{1,1}, C_{1,2} and C_{1,3} for the surface S1 of the pawn P1 and C_{2,1}, C_{2,2} and C_{2,3} for the surface S2 of the pawn P2. Due to the different arrangement on the underside of the pawn, these contact points or pads constitute a signature identifying the pawn.

In order to detect these pads on the surface of the pawn in contact with the touchscreen, said screen is, for example, a capacitive screen. An example embodiment of pawns and a capacitive screen is described in patent application WO 2012/017205. The different arrangements of the pads thus allow the interface of the touch surface to detect which pad is placed on the screen. In a family, for example, a configuration step records the association of a pawn with a member of the family in such a way that, when a pawn is placed on the screen of the terminal, the latter detects the presence of the associated user.

The screen can then display, for example, the representation of this user under the position of the pawn on the screen as shown in FIG. 6a for the pawns P1 and P2 and the representations U1 and U2.

The pawns arranged in this way allow users to perform the interactions on the touch interface of the screen even more easily according to the method described in FIG. 2. The swiping of the representation of the user U1 toward the representation of the user U2 is performed by means of the movement of the pawn P1 toward the pawn P2 as shown in FIG. 6a.

Steps E203 to E206 described in FIG. 2 and in FIGS. 4a to 4d are implemented through the movement of the pawns on the touch surface of the screen. Similarly, as described in FIG. 3b, a graphical object representing the data transfer can also be created on the screen close to the representation of the sending user. This graphical object is shown as D0 in FIG. 6a.

The initialization of the data transfer in step E202 in FIG. 2 can be implemented either through the movement of a single pawn, for example P1 toward P2, or by the movements of the two pawns, both P1 and P2. When the graphical representations of the sending and receiving users are at a predefined distance, for example 0, the initialization step is then implemented.

In one particular embodiment, the identification of the pawn in contact with the screen is performed when the user is in contact with the pawn, for example with his hand as shown in FIG. 6b. In this case, the pawn is made from a conductive material in such a way that the capacitive screen detects the presence of the user on the pawn. In this particular embodiment, the data transfer can be validated only if the respective users are actually in contact with their respective pawn.

The interface of the terminal therefore verifies this criterion before the implementation of step E206. This verification constitutes a step of authenticating the pawn on the interface which requires the physical contact of the user on his pawn. The security of the transfer is thus increased since it is conditional on the handling of the pawns by two users. These two users may be physically present together on the same device. This then constitutes a direct agreement.

In a different embodiment, the two users may be at a distance on different devices, each having placed his pawn on the touch interface of his screen. The display of the graphical representations of the two users is implemented on both devices. Said devices communicate via a, for example mobile, communication network and exchange information relating to displacements and movements of the pawns on the interface in such a way as to implement the transfer aid method as described with reference to FIG. 2.

In order to determine the quantity of data to be transferred from one user portfolio to another, the touch interface of the screen detects a rotation applied to the pawn corresponding to the sending user. This detection of the rotation of a pawn is possible, for example, by means of a method of triangulation of the three capacitive contact points as shown in FIG. 6c.

FIG. 6d shows this step of determining the quantity of data to be transferred through the rotation of the pawn P1. The quantity of data then changes from a value D0 to a value D1 and the graphical object representing the data transfer increases in size as a result. Similarly, as shown in FIG. 6d, the size of the graphical representation of the sending user, here U1, decreases in size as the data quantity of the transfer increases.

It should be noted that this modification of the size of the graphical representation of the users can be carried out after the transfer has been validated.

The interaction by the pawns is very simple to use and is within the capability of everyone.

This type of interaction can also be implemented in interactive game applications where a pawn represents a player.

FIG. 7 now shows a hardware representation of a data transfer aid device 700 according to one embodiment of the invention.

The device includes a storage space 701, for example a memory MEM, and a processing unit 703 equipped, for example, with a processor PROC. The processing unit can be controlled by a program 702, for example a computer program PGR, implementing the data transfer aid method as described with reference to FIG. 2, and notably the steps of swiping the graphical representation of the sending user toward the graphical representation of the receiving user on the screen of the terminal, sending a command to a management unit to initialize the data transfer from the data portfolio of the sending user to the data portfolio of the receiving user when the graphical representation of the sending user is at a predefined distance from the graphical representation of the receiving user, sending a data transfer validation command to the management unit when the graphical representation of the receiving user moves away from the graphical representation of the sending user; and sending a data transfer cancellation command to the management unit when the graphical representation of the sending user moves away from the graphical representation of the receiving user.

The description of FIG. 2 typically follows the steps of an algorithm of a computer program of this type. The computer program may also be stored on a memory medium readable by a reader of the device or downloadable from the memory space of said device.

The memory MEM generally records all the data necessary for the implementation of the method.

On initialization, the instructions of the computer program 702 are, for example, loaded into a RAM memory (Random Access Memory in English) before being executed by the processor of the processing unit 703. The processor of the processing unit 703 carries out the steps of the data transfer aid method according to the computer program instructions 702.

To do this, the device includes, as well as the memory 701, communication means 706 (COM) enabling the device to connect to a telecommunications network and exchange data with other devices via the telecommunications network, and, in particular, to send the data transfer initialization, validation or cancellation commands when the management server is outside the device.

In the case where the management unit is inside the device, said device comprises a management unit 707 which is responsible for allocating new values to the respective portfolios of the users of the transfer. These respective portfolios are, for example, recorded in the memory MEM of the terminal in this embodiment.

The device furthermore comprises a touch interface unit 704 with a display screen 705. This interface unit, also referred to as a touch interface, has a detection module capable of detecting the touch movements performed on the screen in order to move displayed graphical representations. In a second embodiment, this touch interface is capacitive and detects the position, movement and rotation of a pawn comprising a plurality of contact points placed on the screen.

According to one particular embodiment, the device may be integrated into a terminal, for example a smartphone, an electronic tablet or other communication equipment, a computer or multimedia table.

1. Method for aiding the data transfer between a sending user and a receiving user by means of a touch interface of a terminal screen, characterized in that each user has a data portfolio and is represented on the screen by a graphical representation, the method comprising the following steps:
swiping (E201) the graphical representation of the sending user toward the graphical representation of the receiving user on the screen of the terminal;
sending (E202) a command to a management unit to initialize the data transfer from the data portfolio of the sending user to the data portfolio of the receiving user when the graphical representation of the sending user is at a predefined distance from the graphical representation of the receiving user;
sending (E206) a data transfer validation command to the management unit when the graphical representation of the receiving user moves away (E205) from the graphical representation of the sending user; and
sending (E204) a data transfer cancellation command to the management unit when the graphical representation of the sending user moves (E203) away from the graphical representation of the receiving user.

2. Method according to claim 1, characterized in that a parameter for displaying the graphical representation of a user varies according to the remaining quantity of data in his portfolio and in that it is updated following the sending of a transfer validation command.

3. Method according to claim 1, characterized in that the steps of swiping and distancing the graphical representations are carried out through touch interaction and touch movement on the screen.

4. Method according to claim 3, characterized in that it furthermore comprises a step of creating a graphical object representing the transfer of data originating from the sending user on detection of a touch contact of the sending user on his graphical representation displayed on the screen, the size of the graphical object varying according to the quantity of data to be transferred, and in that the transfer validation command comprises information relating to the quantity of data to be transferred.

5. Method according to claim 4, characterized in that the quantity of data to be transferred is determined according to the duration of touch contact, detected on the screen, on the graphical object representing the data transfer.

6. Method according to claim 4, characterized in that the quantity of data to be transferred is determined according to a touch movement of rotation on the screen around the graphical object representing the data transfer.

7. Method according to claim 1, characterized in that the steps of swiping and distancing the graphical representations are carried out through the interaction of pawns identified on the touch interface of the screen and through the movement of the pawns on the screen, a pawn being associated with a user.

8. Method according to claim 7, characterized in that it comprises a step of authenticating a pawn on the touch interface of the screen, the authentication requiring the physical contact of the user on his pawn.

9. Method according to claim 7, characterized in that it furthermore comprises the following steps:
creating a graphical object representing the transfer of data originating from the sending user on detection of the contact of the pawn of the sending user on the touch interface of the screen;
determining the quantity of data to be transferred according to an angle of rotation applied to the pawn of the sending user on the touch interface of the screen, the size of the graphical object varying according to the determined data quantity;
and in that the transfer validation command comprises information relating to the determined data quantity.

10. Device for aiding the data transfer between a sending user and a receiving user comprising a screen with a touch interface, characterized in that each user has a data portfolio and is represented on the screen by a graphical representation, the device comprising:
a module (704) for detecting a swiping on the screen of the graphical representation of the sending user toward the graphical representation of the receiving user;
a command-sending module (706) capable of sending a command to a management unit to initialize the data transfer from the data portfolio of the sending user to the data portfolio of the receiving user when the detection module (704) detects that the graphical representation of the sending user is at a predefined distance from the graphical representation of the receiving user;
the command-sending module (706) being capable of sending a data transfer validation command to a management unit when the detection module (704) detects that the graphical representation of the receiving user is moving away from the graphical representation of the sending user; and of sending a data transfer cancellation command when the detection module (704) detects that the graphical representation of the sending user is moving away from the graphical representation of the receiving user.

11. A Terminal comprising a device for aiding the data transfer between a sending user and a receiving user comprising a screen with a touch interface, characterized in that each user has a data portfolio and is represented on the screen by a graphical representation, the device comprising:
a module (704) for detecting a swiping on the screen of the graphical representation of the sending user toward the graphical representation of the receiving user;
a command-sending module (706) capable of sending a command to a management unit to initialize the data transfer from the data portfolio of the sending user to the data portfolio of the receiving user when the detection module (704) detects that the graphical representation of the sending user is at a predefined distance from the graphical representation of the receiving user;
the command-sending module (706) being capable of sending a data transfer validation command to a management unit when the detection module (704) detects that the graphical representation of the receiving user is moving away from the graphical representation of the sending user; and of sending a data transfer cancellation command when the detection module (704) detects that the graphical representation of the sending user is moving away from the graphical representation of the receiving user.

12. A Computer program comprising code instructions for implementing a data transfer aid method when executed by a processor, the method for aiding the data transfer between a sending user and a receiving user by means of a touch interface of a terminal screen, characterized in that each user has a data portfolio and is represented on the screen by a graphical representation, the method comprising the following steps:
swiping (E201) the graphical representation of the sending user toward the graphical representation of the receiving user on the screen of the terminal;
sending (E202) a command to a management unit to initialize the data transfer from the data portfolio of the sending user to the data portfolio of the receiving user when the graphical representation of the sending user is at a predefined distance from the graphical representation of the receiving user;
sending (E206) a data transfer validation command to the management unit when the graphical representation of the receiving user moves away (E205) from the graphical representation of the sending user; and
sending (E204) a data transfer cancellation command to the management unit when the graphical representation of the sending user moves (E203) away from the graphical representation of the receiving user.

13. A Computer-readable recording medium on which a computer program is recorded, including instructions for carrying out a data transfer aid method, the method for aiding the data transfer between a sending user and a receiving user by means of a touch interface of a terminal screen, characterized in that each user has a data portfolio and is represented on the screen by a graphical representation, the method comprising the following steps:
swiping (E201) the graphical representation of the sending user toward the graphical representation of the receiving user on the screen of the terminal;
sending (E202) a command to a management unit to initialize the data transfer from the data portfolio of the sending user to the data portfolio of the receiving user when the graphical representation of the sending user is at a predefined distance from the graphical representation of the receiving user;
sending (E206) a data transfer validation command to the management unit when the graphical representation of the receiving user moves away (E205) from the graphical representation of the sending user; and
sending (E204) a data transfer cancellation command to the management unit when the graphical representation of the sending user moves (E203) away from the graphical representation of the receiving user.

14. Method according to claim 2, characterized in that the steps of swiping and distancing the graphical representations are carried out through touch interaction and touch movement on the screen.

15. Method according to claim 2, characterized in that the steps of swiping and distancing the graphical representations are carried out through the interaction of pawns identified on the touch interface of the screen and through the movement of the pawns on the screen, a pawn being associated with a user.

16. Method according to claim 8, characterized in that it furthermore comprises the following steps:
creating a graphical object representing the transfer of data originating from the sending user on detection of the contact of the pawn of the sending user on the touch interface of the screen;
determining the quantity of data to be transferred according to an angle of rotation applied to the pawn of the sending user on the touch interface of the screen, the size of the graphical object varying according to the determined data quantity;
and in that the transfer validation command comprises information relating to the determined data quantity.
